(19) United States
(12) Patent Application Publication
(10) Pub. No.: US 2015/0167876 A1
(43) Pub. Date: Jun. 18, 2015

(54) HOSE END-FITTINGS

(71) Applicant: Brown & Miller Racing Solutions Limited, Slough (GB)

(72) Inventor: Barry Charles MILLER, Egham (GB)

(21) Appl. No.: 14/568,421

(22) Filed: Dec. 12, 2014

(30) Foreign Application Priority Data
Dec. 13, 2013 (GB) 1322133.8

(51) Int. Cl. F16L 33/32; F16L 15/08; F16L 15/00

(52) U.S. Cl. CPC F16L 33/32; F16L 15/001; F16L 15/08; F16L 2201/20

(57) ABSTRACT

A hose end-fitting has a cylindrical end-attachment for the hose and an annular nut with an internal thread is secured coaxially on the end-attachment by a wire element that is wedged between the end-attachment and the nut within axially-aligned annular grooves that indent external and internal cylindrical surfaces of the end-attachment and nut respectively, wherein the groove-indented internal surface of the nut has a diameter at that groove which lies within a range that extends from a diameter larger than the peak diameter of the internal thread of the nut, to a diameter which is the same or at least substantially the same as the root diameter of the internal screw thread.

This application claims priority from Great Britain application no. 1322133.8 filed on Dec. 13, 2013.

### FIELD OF THE INVENTION

This invention relates to hose end-fittings.

### BACKGROUND OF THE INVENTION

The invention is particularly concerned with hose end-fittings of the kind in which there is an attachment to the end of the hose and an annular nut with internal threads is secured coaxially to the attachment by a wire element that is wedged between the attachment and the nut within axially-aligned annular grooves that indent the external and internal surfaces of the attachment and nut respectively.

Hose end-fittings of this above-specified kind are known and are used, for example, in hose connections in fuel-supply lines of automobile engines. Where the engines are used in motor-sport, international standards dictate the thread size and mating geometry used in the coupling of the end-fitting via the nut and an adaptor to the engine fuel-system.

### BRIEF DESCRIPTION OF THE DRAWINGS

By way of clarification and further explanation of the known hose end-fitting, reference is now made to the accompanying drawings, in which:

FIGS. 1 and 2 are, respectively, an external elevation and a sectional side-elevation of the known hose end-fitting together with an adaptor to which it is coupled;

FIGS. 3 and 4 are, respectively, an external elevation and a sectional side-elevation of a nut of the known hose end-fitting of FIGS. 1 and 2;

FIG. 5 which shows detail to an enlarged scale of part of the connection between the nut and an attachment of the known hose end-fitting of FIGS. 1 and 2;

FIGS. 6 and 7 are, respectively, an external elevation and a sectional side-elevation of the hose end-fitting according to the present invention, together with an adaptor to which it is coupled;

FIGS. 8 and 9 are, respectively, an external elevation and a sectional side-elevation of a nut of the hose end-fitting of FIGS. 6 and 7; and

FIG. 10 is a partly broken-away perspective view of the nut of the hose end-fitting of FIGS. 6 and 7.

### DETAILED DESCRIPTION OF THE DRAWINGS

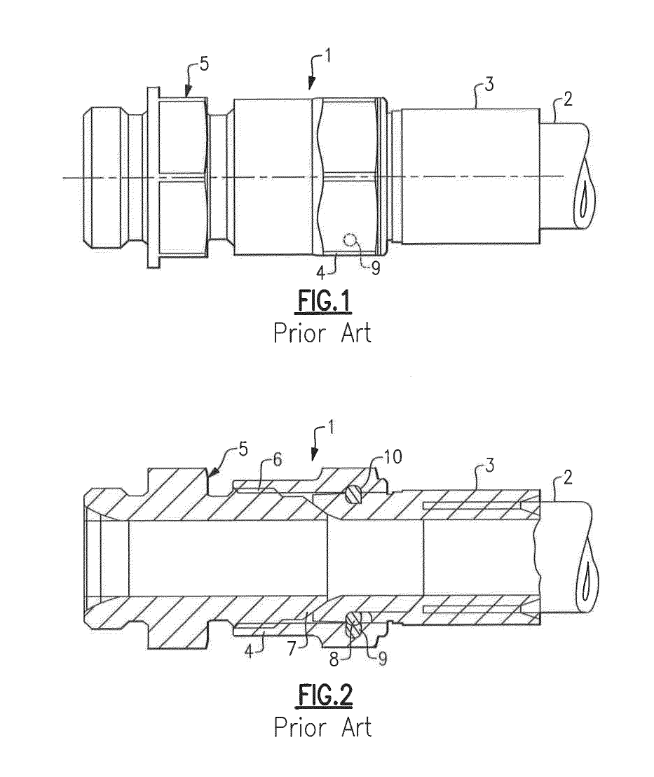

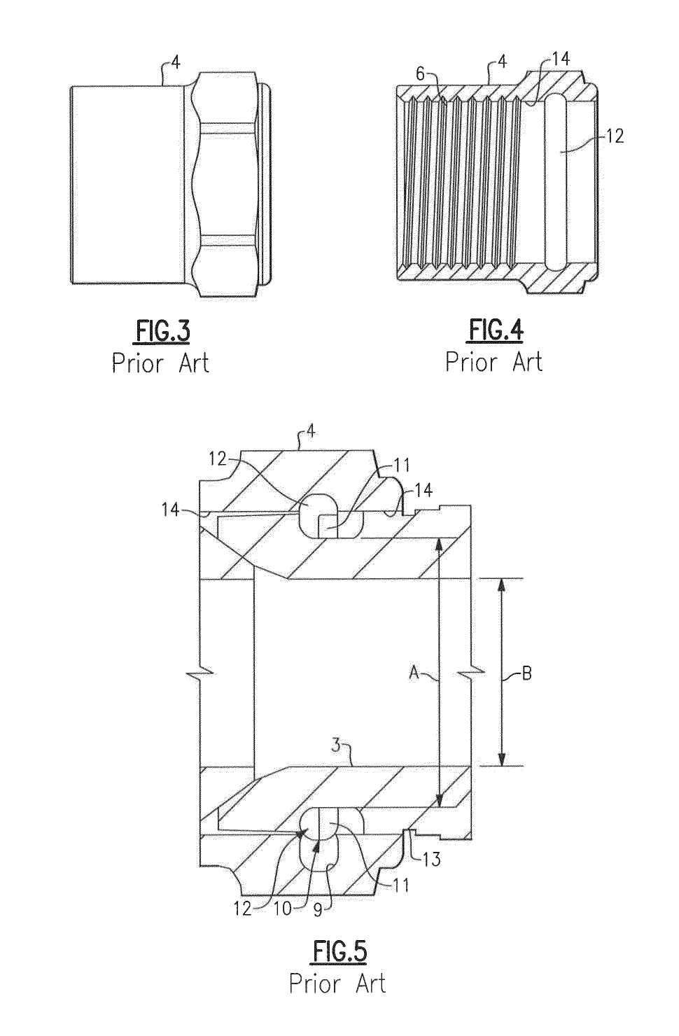

Referring to FIGS. 1 and 2, the known end-fitting 1 is coupled to the fuel-supply hose 2 of an engine (not shown) through an attachment 3 secured to the end of the hose 2, and includes an annular nut 4 (shown in more detail in FIGS. 3 and 4) that is secured coaxially to the attachment 3. The nut 4 retains the attachment 3 coupled via an adaptor 5 to the fuel-system of the engine.

The nut 4 has internal threads 6 that screw onto an externally-threaded nose 7 of the adaptor 5, and is secured to the attachment 3 by a wire element 8 that is wedged between the attachment 3 and the nut 4. In assembly of the end-fitting 1 the wire element 8 is fed through a hole 9 in the nut 4 to extend round the fitting 1 in a passage 10 that is formed as illustrated in FIG. 5 (from which representation of the wire element 8 is omitted) by axially-aligned grooves 11 and 12. The groove 11 indents the external surface 13 of the attachment 3, whereas (as also shown in FIG. 4) the groove 12 indents the internal surface 14 of the nut 4. The wire element 8 trapped in the passage 10 between the aligned grooves 11 and 12 in this way, provides a wedge between the attachment 3 and nut 4 securing the two together.

An important factor in obtaining maximum engine-performance in motor-sport is to avoid as far as possible any constriction of the fuel-supply path, and, to this end, to provide a maximum bore through the hose end-fitting 1 consistent with prevailing international standards. However, the known construction of end-fitting 1 illustrated in FIGS. 1 to 5, imposes a limitation on the maximum bore diameter B (indicated in FIG. 5) that can be adopted, in that if that diameter is increased it introduces structural weakness in the fitting 1. The weakness arises from the reduction of thickness of the attachment 3 at the groove 11 that results from increase of bore diameter. The thickness at the groove 11 is equal to the difference between the diameter A represented in FIG. 5, and the bore diameter B, and it is an object of the present invention to provide a modified form of hose end-fitting that allows an increased bore diameter to be achieved without introducing weakness.

According to one aspect of the present invention, a hose end-fitting of the above-specified kind is provided wherein the groove-indented internal surface of the nut has a diameter at that groove which is at least substantially the same as the major diameter of the internal threads of the nut, namely, the diameter defined by the roots of those threads.

The groove-indented internal surface of the nut in the hose end-fitting of the present invention is thus of larger diameter than the corresponding surface in the known hose end-fitting. More especially, the diameter of the corresponding surface of the known hose end-fitting is at least substantially the same as the minor diameter of the internal threads of the nut, namely the diameter defined by the peaks of those threads, and therefore less than in the hose end-fitting of the invention. The increase in diameter of the groove-indented surface of the nut afforded by the present invention enables an increase to be made in the diameter of the bore through the attachment of the end-fitting and the adaptor, without compromising the structural integrity of the fitting or the applicable international motor-sport standards.

A hose end-fitting according to the invention will now be described, by way of example, with reference to the further drawings accompanying this application, in which:

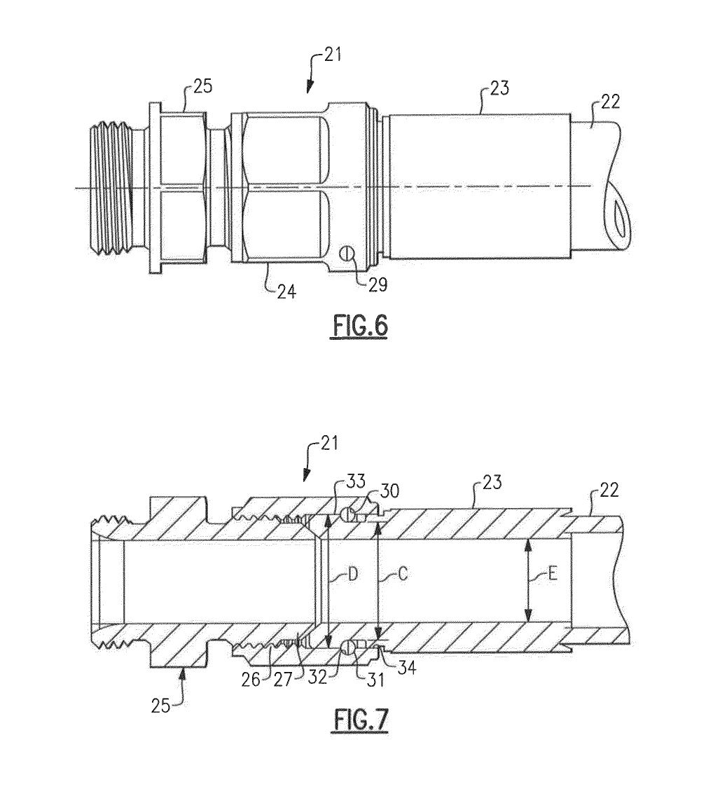

FIGS. 6 and 7 are, respectively, an external elevation and a sectional side-elevation of the hose end-fitting according to the present invention, together with an adaptor to which it is coupled;

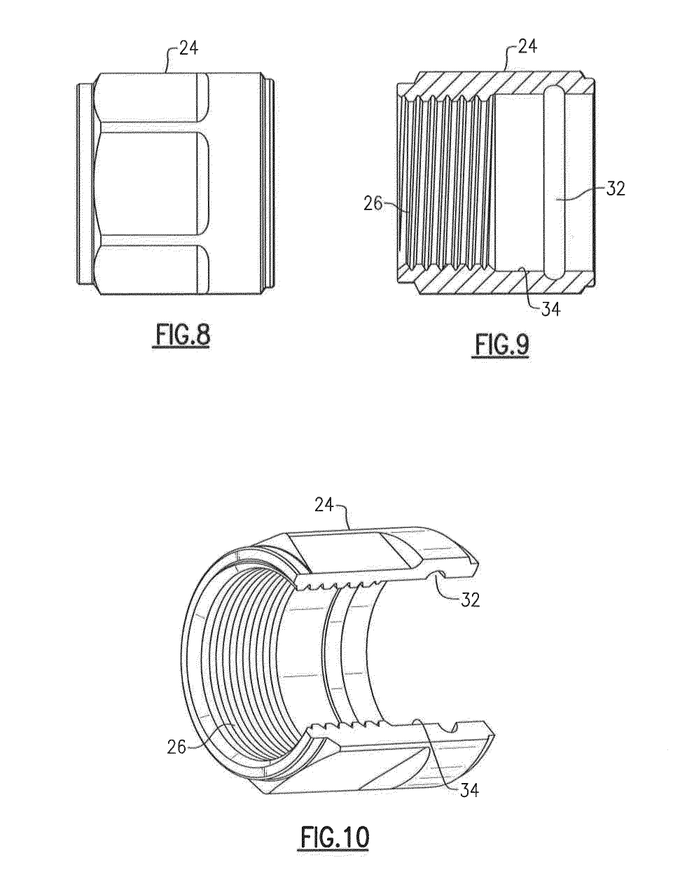

FIGS. 8 and 9 are, respectively, an external elevation and a sectional side-elevation of a nut of the hose end-fitting of FIGS. 6 and 7; and

FIG. 10 is a partly broken-away perspective view of the nut of the hose end-fitting of FIGS. 6 and 7.

Referring to FIGS. 6 and 7, the end-fitting 21 of the invention, in a comparable way to the known end-fitting 1, is coupled to an engine fuel-supply hose 22 through an attachment 23, and includes an annular nut 24 (shown in more detail in FIGS. 8 to 10) that is secured coaxially to the attachment 23 for retaining the attachment 23 coupled via an adaptor 25 to the fuel-system of the engine. The nut 24 has internal threads 26 that screw onto a threaded nose 27 of the adaptor 25 and is secured to the attachment 23 by a wire element 28 (not shown) that having been fed through a hole 29 in the nut 24, is wedged between the attachment 23 and the nut 24, securing them together.

Furthermore, in a comparable way to the construction of the known end-fitting 1, the wire element 28 extends round the fitting 21 in a passage 30 that is formed by axially-aligned grooves 31 and 32 that indent external and internal surfaces 33 and 34 of the attachment 23 and nut 24 respectively, to establish a wedge between them. However, in this case, according to the invention, the internal surface 34 of the nut 24, rather than being of the same diameter as the peaks of the internal threads 26 of the nut 24 has the same diameter as the roots of the threads 26. Accordingly, the surface 34 into which the groove 32 is indented is at the major diameter of the internal threads 6 of the nut 24 rather than at the minor diameter as in the known end-fitting, as is clear from FIGS. 9 and 10.

The increase in diameter of the surface from which the groove 32 is indented enables an increase in the diameter A indicated in FIG. 5, of twice the depth of the threads 26, to the diameter C indicated in FIG. 7. A corresponding increase in diameter can thus be made to the surface from which the groove 31 is indented, namely to enable increased diameter Q indicated in FIG. 7, without compromising structural integrity. Moreover, these increases in diameters enables the bore diameter through the end-fitting 21 and adaptor 25 to be correspondingly increased to the diameter E indicated in FIG. 7.

The hexagonal formation of the external surface of the nut 24 of the end-fitting 21 of the invention is extended longitudinally of the fitting as compared with that of the nut 4 of the known end-fitting 1. This adds to the structural soundness of the fitting of the invention.

Although the invention has been described in the context of motor-sport and its application to the supply of fuel to an engine, it is to be understood that the invention has wider application than this in different contexts, and is applicable generally to improving and achieving more-efficient flow where liquids and other fluids are conveyed.

1. A hose end-fitting comprising:
an end-attachment for a hose, the end-attachment having an external cylindrical surface indented by a first annular groove,
an annular nut having an internal cylindrical surface that is indented by a second annular groove, the annular nut being mounted coaxially on the external cylindrical surface of the end-attachment with the second annular groove axially-aligned with the first annular groove to form with the first annular groove an annular passage round the end-fitting between the annular nut and the end-attachment, and
a wire element within the annular passage wedging the annular nut and the end-attachment together,
wherein the annular nut has an internal screw thread, the screw thread has a root diameter and a peak diameter, and wherein the internal cylindrical surface of the annular nut at the second groove has a diameter that is larger than the peak diameter of the internal screw thread of the annular nut.

2. The hose end-fitting according to claim 1, wherein the internal cylindrical surface of the annular nut at the second groove has a diameter which lies within a range that extends from a diameter larger than the peak diameter of the internal screw thread of the annular nut, to a diameter equal to the root diameter of the internal screw thread.

3. The hose end-fitting according to claim 1, wherein the diameter of the internal cylindrical surface of the annular nut at the second groove is the same as the root diameter of the internal screw thread of the annular nut.

4. The hose end-fitting according to claim 1, wherein the wire element extends into the annular passage through a hole in the annular nut.

5. The hose end-fitting according to claim 1, including an adaptor for coupling the hose via the hose end-fitting to an external facility, wherein the annular nut is screwed to the adaptor via the internal screw thread of the annular nut.

6. The hose end-fitting according to claim 5, wherein the external facility is an engine, and the hose is for supplying fuel to the engine via the hose end-fitting.

7. A hose end-fitting for coupling a fuel-supply hose into a fuel-supply line of an automobile engine, wherein the hose end-fitting comprises:
an end-attachment for coupling to the fuel-supply hose in the fuel-supply line, the end-attachment has an internal axial bore and an external cylindrical surface indented by a first annular groove,
an annular nut having an internal cylindrical surface that is indented by a second annular groove, the annular nut being mounted coaxially on the external cylindrical surface of the end-attachment with the second annular groove axially-aligned with the first annular groove to form with the first annular groove an annular passage round the end-fitting between the annular nut and the end-attachment, and
a wire element within the annular passage wedging the annular nut and the end-attachment together,
wherein the annular nut has an internal screw thread for coupling the end-attachment in the fuel-supply line leading from the fuel-supply hose towards the automobile engine, the internal screw thread of the annular nut has a root diameter and a peak diameter,
wherein the internal cylindrical surface of the annular nut at the second groove has a diameter that is larger than the peak diameter of the internal screw thread of the annular nut, and
wherein the internal axial bore of the end-attachment is of a constant diameter.

8. The hose end-fitting according to claim 7, wherein the internal cylindrical surface of the annular nut at the second groove has a diameter within a range which extends from a diameter larger than the peak diameter of the internal screw thread of the annular nut, to a diameter equal to the root diameter of the internal screw thread.

9. The hose end-fitting according to claim 7, wherein the diameter of the internal cylindrical surface of the annular nut at the second groove is the same as the root diameter of the internal screw thread of the annular nut.

10. The hose end-fitting according to claim 7, wherein the wire element extends into the passage through a hole in the annular nut.

11. A hose end-fitting for coupling a fuel-supply hose into a fuel-supply line of an automobile engine, wherein the hose end-fitting comprises:
an end-attachment for coupling to the fuel-supply hose in the fuel-supply line, the end-attachment has an internal axial bore and an external cylindrical surface indented by a first annular groove,
an annular nut having an internal cylindrical surface that is indented by a second annular groove, the annular nut being mounted coaxially on the external cylindrical surface of the end-attachment with the second annular groove axially-aligned with the first annular groove to form with the first annular groove an annular passage round the end-fitting between the annular nut and the end-attachment,
a wire element within the annular passage wedging the annular nut and the end-attachment together, and
a cylindrical adaptor for coupling the end-attachment to the automobile engine in the fuel-supply line, the adaptor having an external screw thread and an axial bore,
wherein the annular nut has an internal screw thread that has a root diameter and a peak diameter, the internal screw thread of the annular nut being screwed to the external screw thread of the end-attachment with the axial bore of the cylindrical adaptor aligned with the axial bore of the end-attachment,
wherein the internal cylindrical surface of the annular nut at the second groove has a diameter that is larger than the peak diameter of the internal screw thread of the annular nut, and
wherein the internal axial bore of the adaptor and the internal axial bore of the end-attachment are of a same constant diameter as one another.

12. The hose end-fitting according to claim 11, wherein the internal cylindrical surface of the annular nut at the second groove has a diameter within a range which extends from a diameter larger than the peak diameter of the internal screw thread of the annular nut, to a diameter equal to the root diameter of the internal screw thread.

13. The hose end-fitting according to claim 11, wherein the diameter of the internal cylindrical surface of the annular nut at the second groove is the same as the root diameter of the internal screw thread of the annular nut.

14. The hose end-fitting according to claim 11, wherein the wire element extends into the passage through a hole in the annular nut.
